(19) United States
(12) Patent Application Publication
(10) Pub. No.: US 2004/0081381 A1
(43) Pub. Date: Apr. 29, 2004

(54) Method and assemblies utilizing a drawn race in a compression bearing assembly

(76) Inventors: David E. Bureaugard, Litchfield, CT (US); Gregory M. Cummings, Harwinton, CT (US); James A. Hilby, Litchfield, CT (US)

Correspondence Address: MICHAEL BEST & FRIEDRICH LLP, 3773 CORPORATE PARKWAY, SUITE 360, CENTER VALLEY, PA, 18034-8217, US

(21) Appl. No.: 10/470,767

(22) PCT Filed: Feb. 5, 2002
(86) PCT No.: PCT/IB02/00353

(51) Int. Cl. F16C 33/58

(52) U.S. Cl. 384/569

(57) ABSTRACT

A method of manufacturing a compressor housing assembly including a drawn race bearing assembly. The method comprises the steps of: providing a housing body having a face surface; machining a shaft bore through the face surface; press fitting a drawn outer race into the shaft bore; machining at least one piston cylinder bore into the face surface after the outer race is positioned in the shaft bore; and securing a roller assembly within the shaft bore in alignment with the drawn outer race.

### BACKGROUND

The present invention relates to radial bearing assemblies. More particularly, the present invention relates to a radial bearing assembly positioned within an internal bore of a housing, for example, a shaft bore in a swashplate air conditioning compressor assembly.

An example of a fixed displacement compressor assembly 5 incorporating the present invention is illustrated in section in FIG. 1. The compressor assembly 5 includes a main shaft 10 supported in shaft bores 20 extending through opposed, interconnected housings 12. The shaft 10 is supported in each shaft bore 20 by a respective radial bearing assembly 50.

Referring to FIG. 2, each housing 12 has the shaft bore 20, a plurality of compressed fluid passages 22 and a plurality of cylinder bores 24. The cylinder bores 24 are configured for reciprocating motion of pistons 16 therein. A clearance between the piston 16 and respective cylinder bore 24 is necessary for smooth operation of the piston 16, but it is desirable to minimize the clearance to prevent fluid leakage and maximize the compressor efficiency.

To ensure the proper piston clearance, the cylinder bores 24 are precisely machined and steps are taken to avoid any distortion of the cylinder bores 24. Such distortion may compromise the fit between the piston 16 and the cylinder bore 24, resulting in a reduced compressor efficiency. In this effort, machined race roller bearings are generally used for radial shaft 10 support. The machined race bearings can be manufactured to tight tolerances and require little or no press fitting into the shaft bore 20, thereby reducing the potential for cylinder bore 24 distortion during insertion of the machined race bearing. While the machined race bearings are effective, they are relatively expensive to manufacture.

Accordingly, there is a desire for a method to provide a bearing assembly utilizing a fairly inexpensive, effective radial bearing assembly that can be installed in a compressor shaft bore 20 while maintaining a limited risk of distorting the cylinder bores 24.

### SUMMARY

The present invention provides a method of manufacturing a compressor housing assembly including a drawn race bearing assembly. The method comprises the steps of: providing a housing body having a face surface; machining a shaft bore through the face surface; press fitting a drawn outer race into the shaft bore; machining at least one piston cylinder bore into the face surface after the outer race is positioned in the shaft bore; and securing a roller assembly within the shaft bore in alignment with the drawn outer race.

Various drawn race bearing assemblies for use in accordance with the method are also provided.

### BRIEF DESCRIPTION OF THE DRAWINGS

FIG. 1 is a cross-sectional view of an air compressor assembly incorporating radial bearing assemblies that are a first embodiment of the present invention.

FIG. 2 is an isometric view of a housing of the air compressor assembly of FIG. 1.

FIGS. 3 and 4 are isometric and planar, respectively, cross-sectional views of a portion of the housing assembly taken along the line 3-3 in FIG. 2 with an illustrative roller cage assembly aligned therewith.

FIGS. 5-8 are progressive isometric views illustrating the preferred method of manufacturing the housing of FIG. 2.

FIGS. 9 and 10 are isometric and planar, respectively, cross-sectional views similar to FIGS. 3 and 4 illustrating a second embodiment of the present invention.

FIGS. 11 and 12 are isometric and planar, respectively, cross-sectional views similar to FIGS. 3 and 4 illustrating a third embodiment of the present invention.

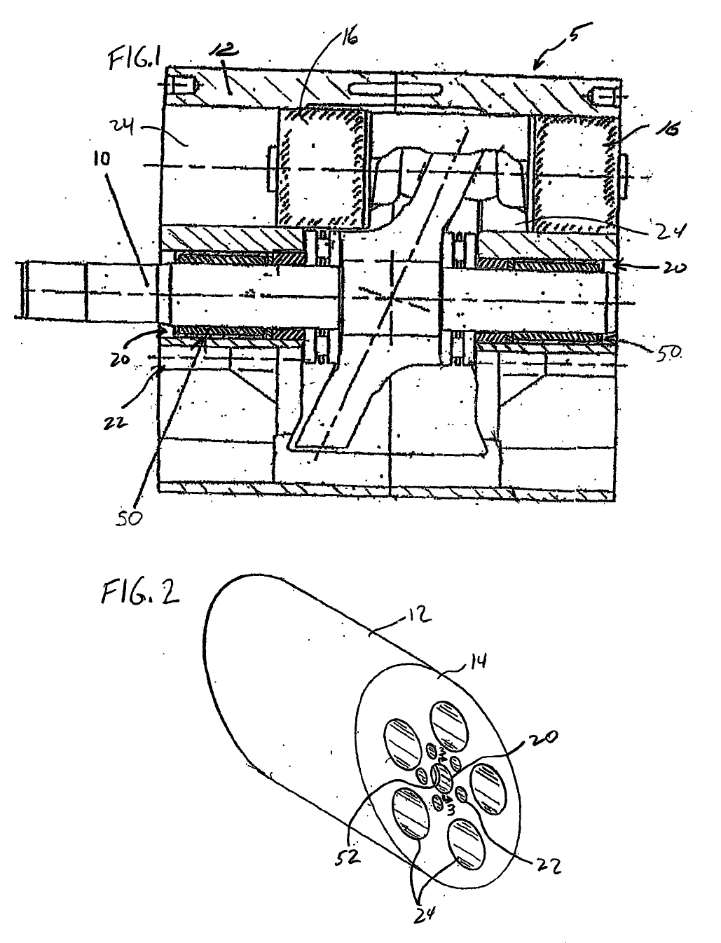

### DETAILED DESCRIPTION OF THE PREFERRED EMBODIMENTS

The present invention will be described with reference to the accompanying drawing figures wherein like numbers represent like elements throughout. Certain terminology, for example, “top”, “bottom”, “right”, “left”, “front”, “frontward”, “forward”, “back”, “rear” and “rearward”, is used in the following description for relative descriptive clarity only and is not intended to be limiting.

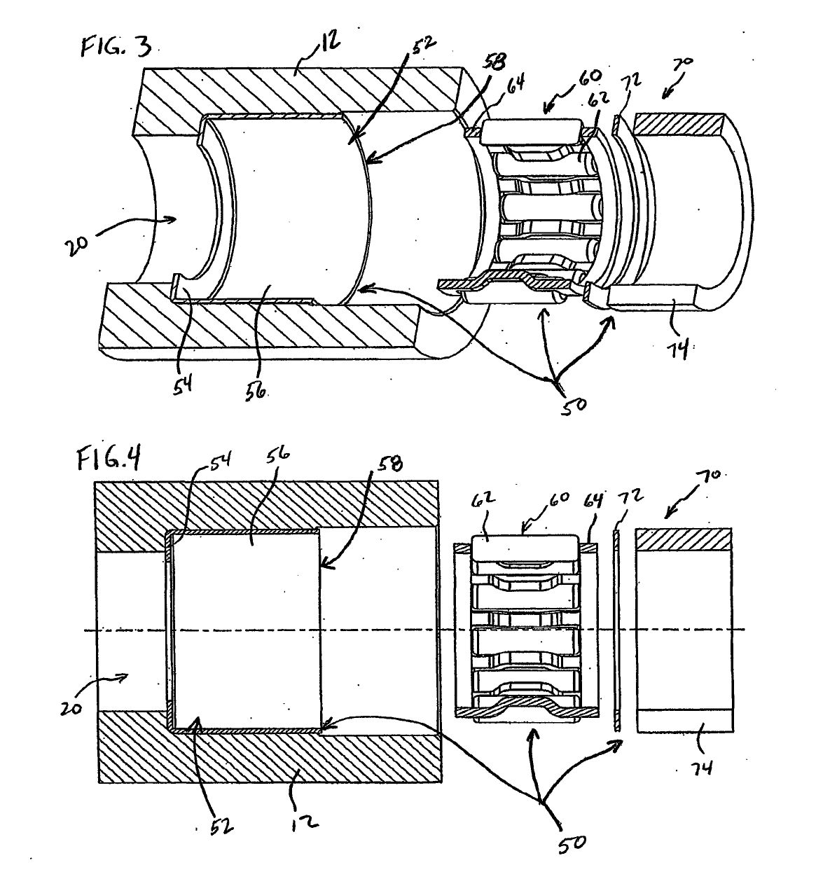

Referring to FIGS. 3 and 4, a bearing assembly 50 in accordance with a first embodiment of the present invention is illustrated. The preferred bearing assembly 50 includes a drawn outer race 52, a roller assembly 60 and a retainer assembly 70. The drawn cup outer race 52 includes an inner lip 54 and a circumferential raceway surface 56 with the end 58 opposite the inner lip 54 being substantially open. The inner lip 54 provides an inner retention surface for the roller assembly 60. The drawn outer race 52 is preferably manufactured from a hardened steel blank with a hardness of approximately 58 HRC that is drawn using known techniques. The drawn outer race 52 has an outside diameter that is equal to, and preferably slightly greater than, the inside diameter of the shaft bore 20 at the intended location of the bearing assembly. As such, the drawn cup outer race 52 is press fit into and retained in the shaft bore 20.

The preferred roller assembly 60 includes a plurality of rollers 62 maintained within a cylindrical cage 64. Other roller assemblies 60 may also be utilized. The open end 58 of the drawn outer race 52 allows the roller assembly 60 to be easily positioned within the outer race 52 with the cage 64 retained on one side by the inner lip 54. After the roller assembly 60 is inserted, the retainer assembly 70 is inserted into the shaft bore 20 to capture the roller assembly 60 within the drawn outer race 52. The retainer assembly 70 preferably includes a hardened washer 72 adjacent the roller assembly cage 64 and a retainer ring 74 that is secured within the shaft bore 20. The retainer ring 74 is preferably a split ring manufactured from a polymer material, for example, a plastic, having an outside diameter slightly greater than inside diameter of the shaft bore 20. The retainer ring 74 is snapped into the shaft bore 20 with an interference fit to retain the washer 72 and thereby the roller assembly 60. The plastic character of the retainer ring 74 reduces the potential for distortion of the cylinder bores 24. In a situation where the drawn outer race 52 is the same length as the bearing bore and an end plate of suitable wear resistance exists in the compressor design, the end plate replaces the retainer assembly 70.

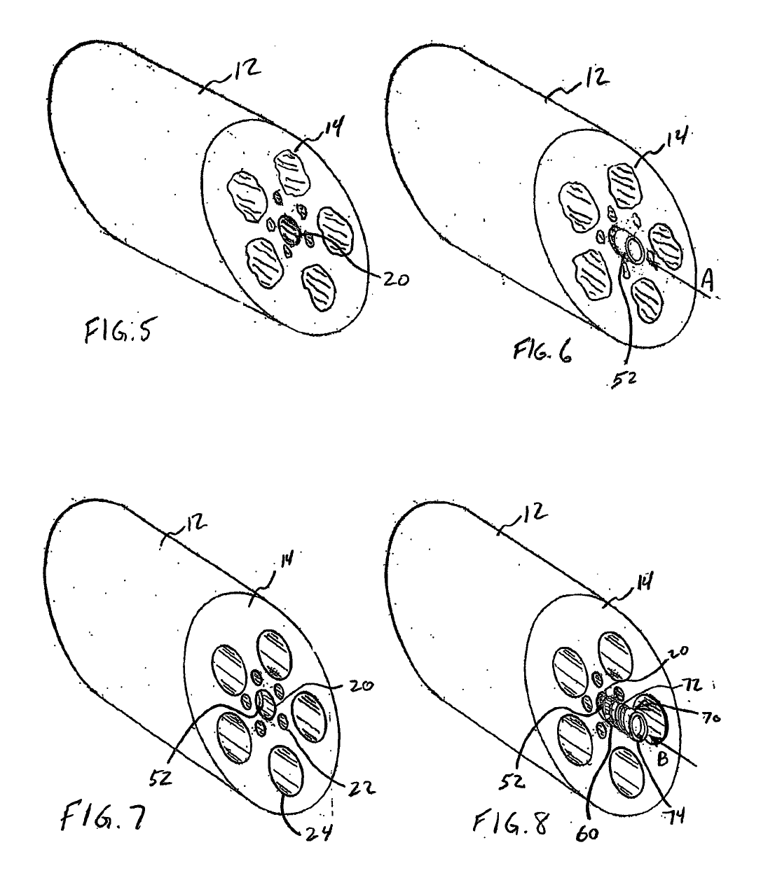

Referring to FIGS. 5-8, the preferred method of manufacturing the bearing assembly 50 and positioning it within the housing 12 is illustrated. Referring to FIG. 5, the housing 12 is preferably cast with somewhat rough fluid passages 22′ and cylinder bores 24′. The shaft bore 20 is also somewhat rough, but is finished, for example, by machining, boring or another finishing technique. Finishing as used herein incorporates various methods, but generally relates to finishing the surface to desired characteristics, for example, desired dimensions and smoothness. While the bores 20, 24 and passages 22 are preferably cast in the housing 12, other methods can also be used. For example, the bores 20, 24 and passages 22 may be machined into a solid housing (not shown). Also, while it is preferable to finish the fluid passages 22 at the same time as the cylinder bores 24, such may not be necessary as the passages 22 do not require as tight tolerances.

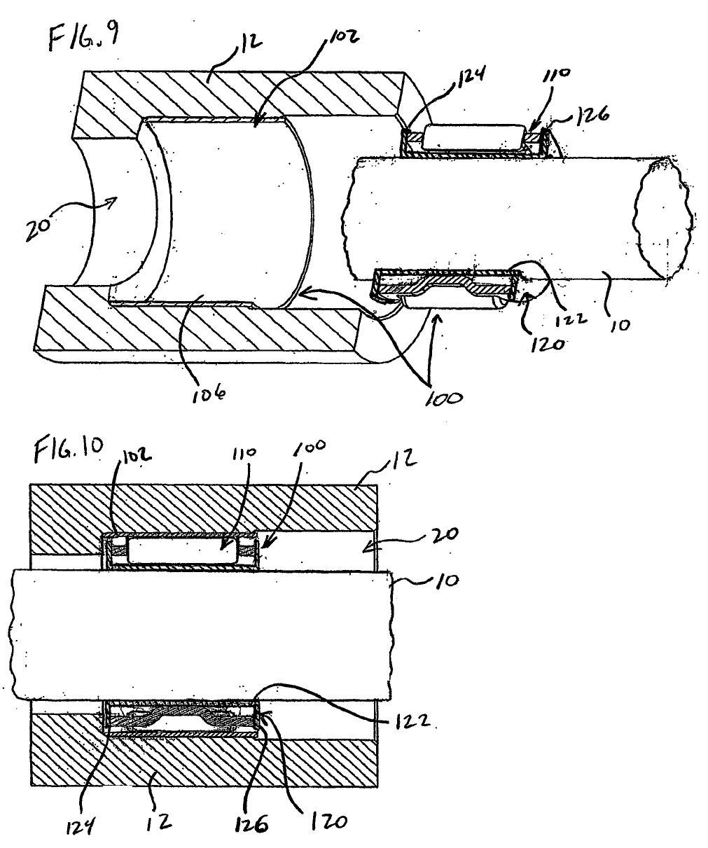

The drawn outer race 52 is press fit into the shaft bore 20 to a desired position as indicated by the arrow A in FIG. 6. After the drawn outer race 52 has been inserted, each of the fluid passages 22 and cylinder bores 24 is finished as illustrated in FIG. 7. Since the drawn outer race 52 is already positioned, it does not impact the finishing of the cylinder bore 24. The cylinder bores 24 can be finished to any desired tolerance. After the bores 22 and 24 are finished, the roller assembly 60 is inserted into the drawn outer race 52 and secured by the retainer assembly 70, as indicated by arrow B in FIG. 8. Since the insertion of the roller assembly 60 and the retainer assembly 70 do not exert an excessive outward force on the shaft bore 20, the risk of cylinder bore 24 distortion is minimized.

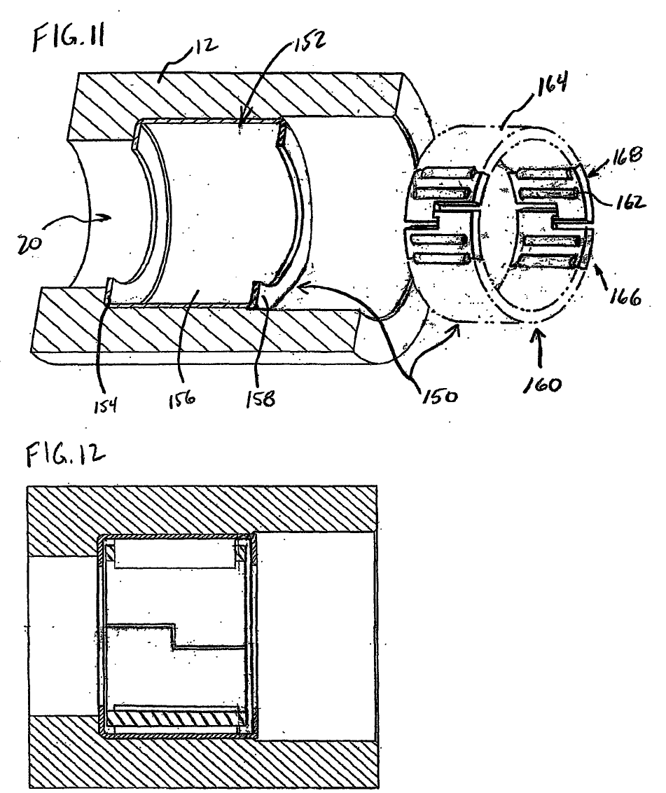

Referring to FIGS. 9 and 10, a roller bearing assembly 100 that is a second embodiment of the present invention is illustrated. The bearing assembly 100 includes a drawn outer race 102, a roller assembly 110 and an inverted drawn inner race 120. The drawn outer race 102 is similar to drawn outer race 52, but preferably does not include an inner lip, but instead is substantially open at both ends. The circumferential portion 106 of the drawn outer race 102 has an outer diameter slightly larger than the inside diameter of the shaft bore 20 and is press fit therein. As in the previous embodiment, the outer drawn race 102 is press fit into the shaft bore 20 prior to finishing of the cylinder bores 24. The inverted drawn inner race 120 is formed with a circumferential inner surface 122 and opposed lips 124 and 126 substantially perpendicular thereto. The drawn inner race 120 is preferably formed with the roller assembly 110 retained therein, i.e., the roller assembly 110 is positioned about the circumferential inner surface 122 prior to formation of the second lip 126. Alternatively, the roller assembly 110 may be a split cage assembly that is positioned about the inner surface 122 after drawing of both lips 124, 126. The drawn inner race 120 is positioned about and secured to the shaft 10 to define the positioning of the roller assembly 110. The drawn inner race 120 is preferably press fit onto the shaft 10, however, other connection methods, for example, the use of splines, may also be used. With the inner race 120 positioned thereabout, the shaft 10 is extended through the shaft bore 20 until the roller assembly 110 is aligned with the drawn outer race 102. Insertion of the shaft 10 with the drawn inner race 120 and roller assembly 110 thereabout provides little risk of cylinder bore 24 distortion.

Referring to FIGS. 11 and 12, a roller bearing assembly 150 that is a third embodiment of the present invention is illustrated. The bearing assembly 150 includes a drawn outer race 152 and a split ring roller assembly 160. The drawn outer race 152 is similar to drawn outer race 52, but includes inner and outer lips 154 and 158 on opposite sides of the circumferential portion 156. Again, the circumferential portion 156 of the drawn outer race 152 has an outer diameter slightly larger than the inside diameter of the shaft bore 20 and is press fit therein. As in the previous embodiments, the outer drawn race 152 is press fit into the shaft bore 20 prior to machining of the cylinder bores 24. The roller assembly 160 preferably includes a plurality of rollers 162 maintained in a polymer split ring cage 164. The illustrated cage 164 has two interlocking halves 166 and 168. After finishing of the cylinder bores 24, a first half 166 of the cage 164 is positioned in the pre-positioned drawn outer race 152 and then the second half 168 of the cage 164 is positioned in the outer race 152 and interconnected with the first half 166. The polymer material allows the cage 164 sufficient flexibility to be positioned within the opposed outer race lips 154 and 158. Additionally, the cage 164 can be split into more than two pieces to further facilitate insertion. Alternatively, the split cage 164 can be a single unit with only one split. The flexible nature of the cage 164 allows it to be compressed upon itself and then snapped into the drawn outer race 152 after positioning therein. Insertion of the split cage 164 provides little risk of cylinder bore 24 distortion.

What is claimed is:

1. A method of manufacturing a compressor housing assembly comprising the steps of:
a) providing a housing body having a face surface;
b) finishing a shaft bore in the face surface;
c) press fitting a drawn outer race into the shaft bore;
d) finishing at least one piston cylinder bore into the face surface after completing step c;
e) securing a roller assembly within the shaft bore in alignment with the drawn outer race.

2. The method according to claim 1 wherein the securing step includes interference fitting a polymer retaining ring into the shaft bore adjacent the drawn outer race.

3. The method according to claim 1 wherein the securing step includes providing a compressor end plate with an integral wear washer.

4. The method according to claim 1 wherein the securing step includes providing an inverted inner race with opposed retaining lips, positioning the roller assembly about the inner race within the retaining lips, and securing the inner race to a shaft to be positioned in the shaft bore.

5. The method according to claim 1 wherein the drawn outer race includes opposed retaining lips and the roller assembly includes a split cage and wherein the securing step includes assembling the split cage within the retaining lips.

6. A radial bearing assembly comprising:
a drawn outer race adapted for press fitting in a shaft bore, the drawn outer race including a circumferential portion having a lip at a first end thereof and being substantially open at the opposite end;
a roller assembly having first and second ends and positionable within the drawn outer race with the first end adjacent the lip;
a retainer assembly adapted to be secured within the shaft bore adjacent the second end of the roller assembly to secure the roller assembly in alignment with the circumferential portion of the drawn outer race.

7. The assembly of claim 6 wherein the retainer assembly includes a hardened washer having first and second sides, the first washer side positioned adjacent the roller bearing second end and a split ring securable adjacent the second washer side.

8. The assembly of claim 7 wherein the split ring is manufactured from a polymer material.

9. A radial bearing assembly comprising:
a drawn outer race adapted for press fitting in a shaft bore, the drawn outer race including a circumferential portion having at least one substantially open end;
a drawn inner race having an inner surface having opposed ends with a retaining lip extending from each inner surface end, the inner surface adapted to be secured to a portion of a shaft aligned with the drawn outer race circumferential portion; and
a roller assembly positioned about the inner race inner surface between the lips.

10. A radial bearing assembly comprising:
a drawn outer race adapted for press fitting in a shaft bore, the drawn outer race including a circumferential portion having opposed ends with a retaining lip extending from each end; and
a roller assembly including a split cage configured to be positioned in and assembled within the outer race between the lips.
